(19) United States
(12) Patent Application Publication
(10) Pub. No.: US 2026/0228869 A1
(43) Pub. Date: Aug. 6, 2026

(54) ENERGY AWARE SL-HDR

(71) Applicant: InterDigital CE Patent Holdings, SAS, Paris (FR)

(72) Inventors: Olivier Le Meur, TALENSAC (FR); Franck Aumont, VERN SUR SEICHE (FR); David Touze, RENNES (FR); Frederic Plissonneau, Thorigne-Fouillard (FR)

(21) Appl. No.: 19/150,852

(22) PCT Filed: Jan. 16, 2024
(86) PCT No.: PCT/EP2024/050909

§ 371 Date: Jul. 24, 2025

(30) Foreign Application Priority Data
Jan. 25, 2023 (EP) 23305093.9

(51) Int. Cl. G06T 5/92; G06V 10/60

(52) U.S. Cl. CPC G06T 5/92; G06V 10/60; G06T 2207/20208

(57) ABSTRACT

A method comprising: obtaining (140) reconstructed SDR data and metadata representative of a first inverse tone mapping function allowing transforming the reconstructed SDR data into HDR data with a dynamic range having a first peak luminance; deriving (141), using the metadata, a second tone mapping function allowing transforming the SDR data into HDR data with a dynamic range having a second peak luminance lower than the first peak luminance; reconstructing (143) the HDR data using the second tone mapping function, the HDR data being intended to be displayed on a display device; wherein: the second peak luminance is lower than a third peak luminance supported by the display device.

### 1. CROSS REFERENCE TO RELATED APPLICATIONS

This application claims priority to European Application No. 23305093.9, filed Jan. 25, 2023, which is incorporated herein by reference in its entirety.

### 2. TECHNICAL FIELD

At least one of the present embodiments generally relates to the field of display of High Dynamic Range (HDR) video and more particularly to a method and a device for controlling an energy consumed for displaying HDR video.

### 3. BACKGROUND

Recent advancements in display technologies allow for an extended dynamic range of color, luminance and contrast in images to be displayed. The term image refers here to an image content that can be for example a video or a still picture or image.

High-dynamic-range video (HDR video) describes video having a dynamic range greater than that of standard-dynamic-range video (SDR video). HDR video based applications involves capture, production, content/encoding, and display. HDR capture and display devices are capable of brighter whites and deeper blacks. To accommodate this, HDR encoding standards allow for a higher maximum luminance and use at least a 10-bit dynamic range (compared to 8-bit (for non-professional) and 10-bit (for professional) dynamic ranges for SDR video) in order to maintain precision across this extended range.

HDR technology offers a better viewer experience (or Quality of Experience (QoE)) of video contents, but the energy consumption is much more significant than SDR. Indeed, the display of a HDR video consumes up to two times more energy than a SDR video. A current trend in many domains being to reduce the consumption of energy, it is desirable to overcome the above drawbacks.

It is particularly desirable to propose a solution allowing controlling or reducing the energy consumed by the display of HDR video while preserving as much as possible the improvement of the QoE provided by the HDR technology and the artistic intent of the content creator.

### 4. BRIEF SUMMARY

In a first aspect, one or more of the present embodiments provide a method comprising:
obtaining reconstructed SDR data and metadata representative of a first inverse tone mapping function allowing transforming the reconstructed SDR data into HDR data with a dynamic range having a first peak luminance; deriving, using the metadata, a second tone mapping function allowing transforming the SDR data into HDR data with a dynamic range having a second peak luminance lower than the first peak luminance; and, reconstructing the HDR data using the second tone mapping function, the HDR data being intended to be displayed on a display device;
wherein:
the second peak luminance is lower than a third peak luminance supported by the display device.

In an embodiment, an information representative of the second peak luminance is provided by a user.

In an embodiment, the information representative of the second peak luminance is an energy consumption reduction target or an energy consumption profile selected in a plurality of energy consumption profiles.

In an embodiment, the energy consumption reduction target is converted in the second peak luminance based on an information allowing determining a reduction factor to be applied to the third peak luminance to obtain the second peak luminance, based on a piece wise linear curve or based on a parametric curve.

In an embodiment, control points allowing defining the piece wise linear curve or parameters allowing defining the parametric curve were obtained offline using a large number of video sequences.

In an embodiment, the information allowing determining a reduction factor, control points allowing defining the piece wise linear curve or parameters allowing defining the parametric curve were obtained from the metadata.

In an embodiment, the metadata are dynamic metadata provided for each image of the SDR data, for groups of images of the SDR data, between two scene cuts of the SDR data, per program of the SDR data, per periods of the SDR data, for a duration or for a temporal layer of the SDR data.

In an embodiment, the metadata comprise in addition at least one of information allowing determining a reduction factor, control points allowing defining the piece wise linear curve or parameters allowing defining the parametric curve for a plurality of types of display devices, an information representative of an average luminance of images, information representative of a spatio-temporal event, information representative of a type of a content represented by the SDR data.

In an embodiment, the second peak luminance of a current image results from a smoothing based on second peak luminance values of images preceding the current image.

In an embodiment, the second peak luminance is greater or equal to a minimum value.

In an embodiment, a content adaptive process determines whether the reconstructing of the HDR data uses the second tone mapping function.

In an embodiment, the content adaptive process uses a value indicating a potential of a current image to reduce energy consumption.

In a second aspect, one or more of the present embodiments provide a method comprising:
obtaining SDR data and first metadata representative of a first inverse tone mapping function allowing transforming the SDR data into HDR data with a dynamic range having a first peak luminance; generating second metadata allowing estimating an energy consumed by a display device to display the HDR data with a second peak luminance; and, encoding the SDR data along with the first and second metadata in video data.
wherein:
the second peak luminance is lower than a third peak luminance supported by the display device.

In an embodiment, the second metadata is an information allowing determining a reduction factor to be applied to the third peak luminance to obtain the second peak luminance, is representative of a piece wise linear curve representing an energy consumption in function of a peak luminance or is representative of a parametric curve representing an energy consumption in function of a peak luminance.

In an embodiment, the information represented by the second metadata depends on a content represented by the HDR data.

In a third aspect, one or more of the present embodiments provide a device comprising electronic circuitry configured for:
obtaining reconstructed SDR data and metadata representative of a first inverse tone mapping function allowing transforming the reconstructed SDR data into HDR data with a dynamic range having a first peak luminance;
deriving, using the metadata, a second tone mapping function allowing transforming the SDR data into HDR data with a dynamic range having a second peak luminance lower than the first peak luminance; and,
reconstructing the HDR data using the second tone mapping function, the HDR data being intended to be displayed on a display device;
wherein:
the second peak luminance is lower than a third peak luminance supported by the display device.

In an embodiment, an information representative of the second peak luminance is provided by a user.

In an embodiment, the information representative of the second peak luminance is an energy consumption reduction target or an energy consumption profile selected in a plurality of energy consumption profiles.

In an embodiment, the energy consumption reduction target is converted in the second peak luminance based on an information allowing determining a reduction factor to be applied to the third peak luminance to obtain the second peak luminance, based on a piece wise linear curve or based on a parametric curve.

In an embodiment, control points allowing defining the piece wise linear curve or parameters allowing defining the parametric curve were obtained offline using a large number of video sequences.

In an embodiment, the information allowing determining a reduction factor, control points allowing defining the piece wise linear curve or parameters allowing defining the parametric curve were obtained from the metadata.

In an embodiment, the metadata are dynamic metadata provided for each image of the SDR data, for groups of images of the SDR data, between two scene cuts of the SDR data, per program of the SDR data, per periods of the SDR data, for a duration or for a temporal layer of the SDR data.

In an embodiment, the metadata comprise in addition at least one of information allowing determining a reduction factor, control points allowing defining the piece wise linear curve or parameters allowing defining the parametric curve for a plurality of types of display devices, an information representative of an average luminance of images, information representative of a spatio-temporal event, information representative of a type of a content represented by the SDR data.

In an embodiment, the second peak luminance of a current image results from a smoothing based on second peak luminance values of images preceding the current image.

In an embodiment, the second peak luminance is greater or equal to a minimum value.

In an embodiment, a content adaptive process determines whether the reconstructing of the HDR data uses the second tone mapping function.

In an embodiment, the content adaptive process uses a value indicating a potential of a current image to reduce energy consumption.

In a fourth aspect, one or more of the present embodiments provide a device comprising electronic circuitry configured for:
obtaining SDR data and first metadata representative of a first inverse tone mapping function allowing transforming the SDR data into HDR data with a dynamic range having a first peak luminance;
generating second metadata allowing estimating an energy consumed by a display device to display the HDR data with a second peak luminance; and,
encoding the SDR data along with the first and second metadata in video data.
wherein:
the second peak luminance is lower than a third peak luminance supported by the display device.

In an embodiment, the second metadata is an information allowing determining a reduction factor to be applied to the third peak luminance to obtain the second peak luminance, is representative of a piece wise linear curve representing an energy consumption in function of a peak luminance or is representative of a parametric curve representing an energy consumption in function of a peak luminance.

In an embodiment, the information represented by the second metadata depends on a content represented by the HDR data.

In a fifth aspect, one or more of the present embodiments provide a non-transitory information storage medium storing program code instructions for implementing the method according to the first or the second aspect.

In a sixth aspect, one or more of the present embodiments provide a computer program comprising program code instructions for implementing the method according to the first or the second aspect.

In a seventh aspect, one or more of the present embodiments provide signal generated by the method of the second aspect or by the device of the fourth aspect.

### 5. BRIEF SUMMARY OF THE DRAWINGS

FIG. 1 illustrates schematically an example of context in which the various embodiments are implemented;

FIG. 2A illustrates a tone mapping curve;

FIG. 2B illustrates an inverse tone mapping curve without display adaptation;

FIG. 2C illustrates inverse tone mapping curves with display adaptation;

FIG. 3 presents some energy consumption values for different kinds of scenes, i.e., bright, intermediate, dim scene luminance.

FIG. 4A illustrates schematically an example of hardware architecture of a processing module able to implement various aspects and embodiments;

FIG. 4B illustrates a block diagram of an example of a first system in which various aspects and embodiments are implemented; and,

FIG. 4C illustrates a block diagram of an example of a second system in which various aspects and embodiments are implemented; and,

FIG. 5 illustrates a post-processing process allowing controlling the energy consumed by a display device when displaying an HDR video.

### 6. DETAILED DESCRIPTION

Even if display devices with HDR capabilities have recently appeared, some of them have limited HDR capabilities. For instance, a HDR capable display may have a luminance capability that is lower than a luminance of a HDR signal as defined by the content creator it has to display. For instance, if the reconstructed HDR signal has a peak luminance of “1000” nits and the display can only render up to “500” nits.

An adaptation of the reconstructed signal to the capacity of the display device is therefore required. An adaptation solution would be to clip the reconstructed signal in a range of values admissible by the display device before displaying it. However, this solution is far from preserving the artistic intent of the content creator and QoE allowed by the HDR signal.

When speaking about images, the artistic intent often relies on how tones, i.e., shadows, midtones, highlights, are distributed within the scenes. This is part of a color grading that an artist (i.e., a content creator) has to do in order to convey a desired emotion and/or to define a visual signature of the content.

Tonal zones can be defined as follows:
Shadows: this corresponds to the lowest part of the color distribution (represented for example by an histogram of luminance values of an image) of a considered content;
Midtones: this corresponds to the middle part of the color distribution of the considered content;
Highlights: this corresponds to the highest part of the color distribution of a considered content.

In addition to these three tonal zones, it is common to define a black point as the pixel with the lowest sample value found within the shadows whereas the white point corresponds to the pixel with the lightest sample value found within the highlights.

Obviously, defining such black and white points is key during the color grading performed by artists. Increasing the black point leads to a scene in which areas darker than the black point are clipped. Similarly, decreasing the white point leads to a scene in which areas lighter than the white point are clipped. Clipping the highlights can result in a loss of valuable highlight details.

More “artistic intent” friendly solutions based on a display adaptation were proposed. Display adaptation allows adapting the reconstructed HDR signal to the display device luminance capacities while allowing getting the highest QoE and preserving the artistic intent of the HDR signal. For instance, display adaptation adjusts tones to preserve highlights which cannot be clipped.

By definition, the QoE is higher when the display adaptation adapts the reconstructed HDR signal to the luminance capability of the display device. However, this comes with the highest energy consumption. To make possible a trade-off between energy consumption and QoE, various embodiments described in the following propose to take account the energy consumption in the display adaptation.

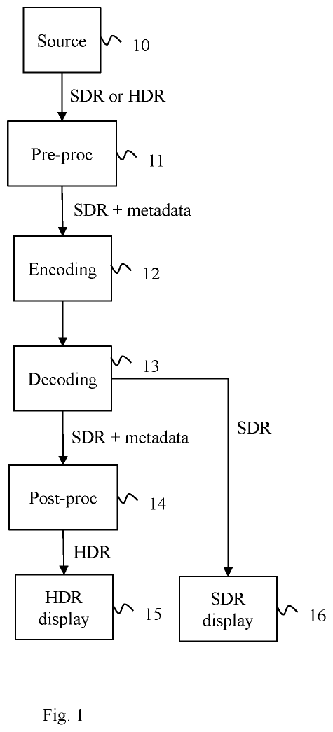

FIG. 1 illustrates schematically an example of context in which the various embodiments are implemented.

In FIG. 1, a source device 10, such as a camera or a streaming system providing a video content, generates a video content. The source device 10 is for instance a SDR or HDR camera generating respectively a SDR or HDR video content.

The video content is then provided to a pre-processing module 11. The pre-processing module 11, for example, adapts a content to a SL-HDRx standard. For instance, the SL-HDRx standard is SL-HDR1. Therefore, when the video content is a SDR video, the pre-processing module generates SL-HDR1 metadata based on the SDR video. When the video content is a HDR video, the pre-processing module applies a tone mapping (TM) to the HDR video to generate a SDR video and generates SL-HDR1 metadata. The HDR video has a peak of luminance called master display peak luminance corresponding generally to a peak luminance defined by the content creator. The SL-HDR1 metadata comprise information representative of an inverse tone mapping function and of a color correction function allowing to obtain a HDR video from a SDR video. These metadata could be dynamic and adapted to each image or group of images.

The SDR video and the SL-HDR1 metadata are then provided to an encoding module 12. The SDR video and the SL-HDR1 metadata are encoded by the encoding module 12 in a bitstream using a video compression format such as AVC ((ISO/CEI 14496-10/ITU-T H.264), HEVC (ISO/IEC 23008-2—MPEG-H Part 2, High Efficiency Video Coding/ITU-T H.265)), VVC (ISO/IEC 23090-3—MPEG-I, Versatile Video Coding/ITU-T H.266), AV1, VP9, EVC (ISO/CEI 23094-1 Essential Video Coding) or any other video compression format adapted to encode a SDR video and SL-HDR1 metadata. The output of the encoding module 12 is a bitstream (i.e., video data) representing the encoded SDR video and the SL-HDR1 metadata.

The encoding module 12 then provides the video data to a decoding module 13 for instance via a network. The decoding module 13 decodes the bitstream to obtain a decoded (i.e., reconstructed) version of the SDR video and the SL-HDR1 metadata.

The reconstructed SDR video is provided directly to a display device 16 adapted to display SDR contents.

The SDR video and the SL-HDR1 metadata are also provided to a post-processing module 14. The post-processing module 14 applies an inverse tone mapping (ITM) step and a color correction step to the SDR video to obtain an HDR video.

The color correction comprises a computation of a Look-Up-Table (LUT) lutCC( ) from the SL-HDR1 metadata. The LUT lutCC( ) is then used to reconstruct the HDR chrominance signal of the HDR video.

For both constant luminance (CL) and non-constant luminance (NCL) modes, lutCC(Y)=f(Y)·(1/Y) with f(Y)=1/(R·sgf(1/Y)) and Y being a value representative of a luminance. Function sgf(1/Y) corresponds to the color correction function encoded in the SL-HDR1 metadata.

In NCL mode, f(Y) is a constant function, i.e., f(Y)=Ω so that lutCC(Y)=Ω·(1/Y).

In CL mode, f(Y) is not a constant function.

The ITM step comprises a derivation of a LUT lutMapY( ) from the SL-HDR1 metadata. The LUT lutMapY( ) is then used to perform the inverse tone mapping of the luminance signal of the SDR video to reconstruct the HDR luminance signal of the HDR video.

When a display adaptation is required (i.e., responsive to the HDR display 15 have a display peak luminance (called target display peak luminance in the following) lower than the master display peak luminance), the target display peak luminance is taken into account during the inverse tone mapping. Three cases are considered:
the target display peak luminance is the same as the master display peak luminance. In that case the ITM curve is the inverse of the TM curve applied by the pre-processing module 11. The LUT lutMapY( ) is therefore derived directly from the SL-HDR1 metadata.
the target display peak luminance is “100” nits (i.e., the HDR display 15 is a SDR display). In that case, the ITM curve is equal to the identity in the linear domain. In other words, when the target display peak luminance is “100” nits, the luminance of the reconstructed HDR signal is equal to the luminance of the reconstructed SDR signal. One can note that this latter is true for NCL mode but is not true for CL mode.
the target display peak luminance is between “100” nits and the master display peak luminance. An ITM curve that is between the identity and the Inverse Tone Mapping curve specified in the SL-HDR1 metadata.

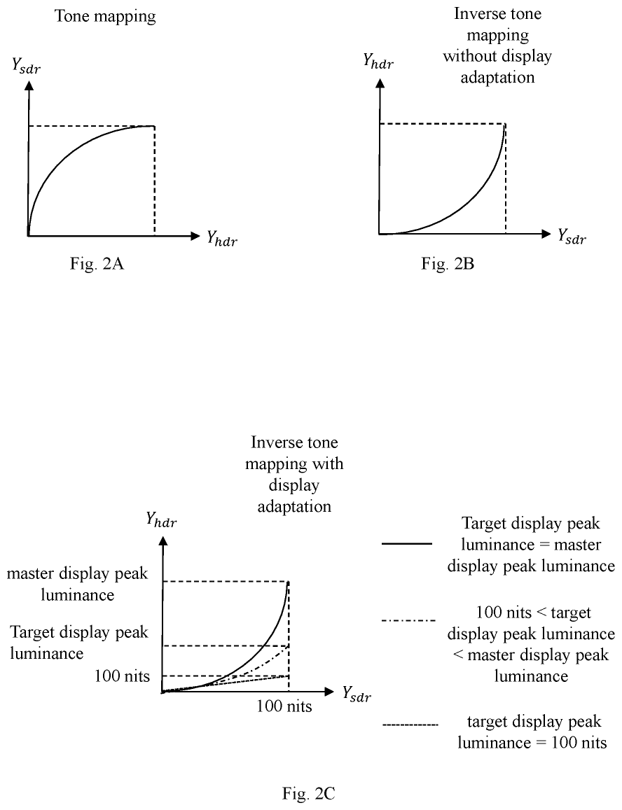

FIG. 2A illustrates a TM curve used by the pre-processing module 11 to generate a SDR video from an original HDR video.

FIG. 2B illustrates an ITM curve resulting from the inversion of the TM curve of FIG. 2A. The sequential application of the TM curve of FIG. 2A and of the ITM curve of FIG. 2B allows (in theory) obtaining back the original HDR video.

FIG. 2C illustrates a plurality of ITM curves obtained from the TM curve of FIG. 2A when a display adaptation process is applied.

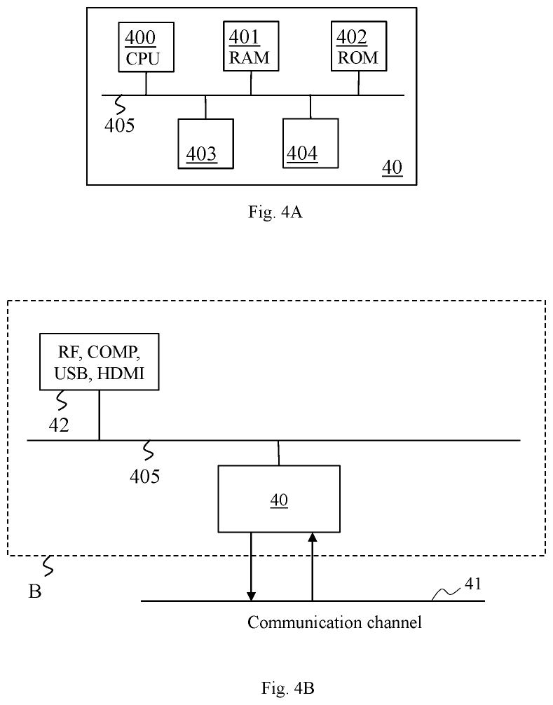

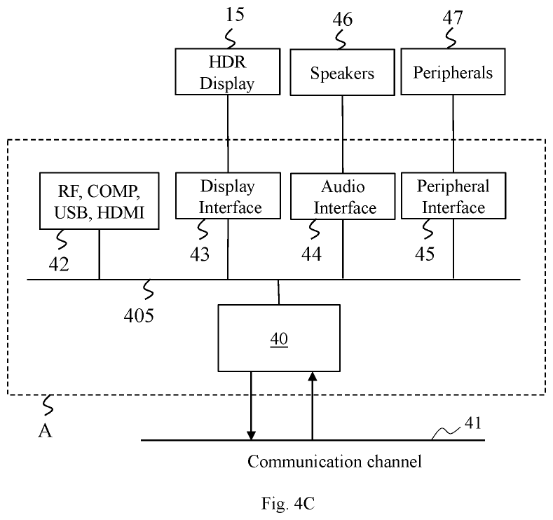

An example of process of deriving the LUT lutMapY( ) when the target display peak luminance is between “100” nits and the master display peak luminance is described in annex E of document ETSI TS 103 433-1 V1.2.1 (High-Performance Single Layer High Dynamic Range (HDR) System for use in Consumer Electronics devices; Part 1: Directly Standard Dynamic Range (SDR) Compatible HDR System (SL-HDR1)) called simply SL-HDR1 in the following. Basically, this process consists in applying the process described in FIG. 4 of section 7.2.3.1.2 of document SL-HDR1 to compute a first LUT lutMapY′( ) representative of the ITM curve without display adaption (i.e. the first LUT lutMapY′( ) allows transforming the reconstructed SDR signal into the HDR signal with a peak of luminance equal to the master display peak luminance) and then to compute a second LUT lutMapY″( ) allowing mapping the HDR signal with a peak of luminance equal to the master display peak luminance to a HDR signal with a peak luminance equal to the target display peak luminance. The LUT lutMapY( ) is then the combination of the first LUT lutMapY′( ) and the second LUT lutMapY″( ). In annex E of document SL-HDR1, the target display peak luminance is called maximum luminance of the presentation display and is represented by a variable L_{pdisp}.

One benefit of the display adaptation process of Annex E of document SL-HDR1 is preserve as much as possible the artistic intent defined by the content creator.

Once reconstructed, the HDR video is then provided to a HDR display 15.

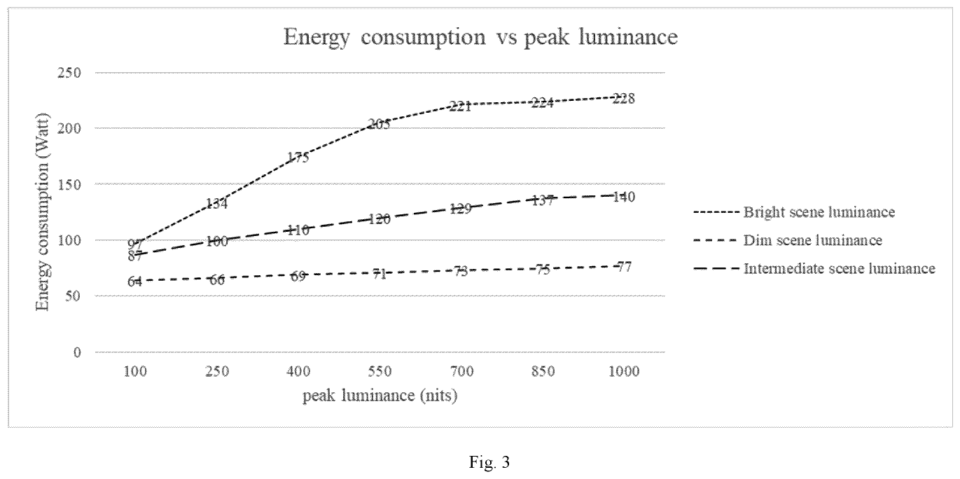

FIG. 3 presents some energy consumption values for different kinds of scenes, i.e., bright, intermediate, dim scene luminance. The energy consumption values are function of a peak luminance expressed in nits. In this example, an OLED screen used for the test has a target display peak luminance of “1000” nits. Its energy consumption is therefore the highest for this value since the full capability of the screen is used. Decreasing the peak luminance of the displayed content allows to decrease the energy consumption. Interestingly, the amount of reduction significantly depends on the scene luminance.

FIG. 4A illustrates schematically an example of hardware architecture of a processing module 40 used for instance in the pre-processing module 11 or in the post-processing module 14. The processing module 40 comprises, connected by a communication bus 405: a processor or CPU (central processing unit) 400 encompassing one or more microprocessors, general purpose computers, special purpose computers, and processors based on a multi-core architecture, as non-limiting examples; a random access memory (RAM) 401; a read only memory (ROM) 402; a storage unit 403, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive, or a storage medium reader, such as a SD (secure digital) card reader and/or a hard disc drive (HDD) and/or a network accessible storage device; at least one communication interface 404 for exchanging data with other modules, devices, systems or equipment. The communication interface 404 can include, but is not limited to, a transceiver configured to transmit and to receive data over a communication network 41. The communication interface 704 can include, but is not limited to, a modem or a network card.

For example, the communication interface 404 enables for instance the processing module 40 to receive the HDR or SDR data and to output HDR or SDR data along with SL-HDR1 metadata.

The processor 400 is capable of executing instructions loaded into the RAM 401 from the ROM 402, from an external memory (not shown), from a storage medium, or from a communication network. When the processing module 40 is powered up, the processor 400 is capable of reading instructions from the RAM 401 and executing them. When the processing module 40 is comprised in the pre-processing module 11, these instructions form a computer program causing, for example, the implementation by the processor 400 of a TM process (when the source module generates a HDR video). When the processing module 40 is comprised in the post-processing module 14, these instructions form a computer program causing, for example, the implementation by the processor 400 of an ITM process comprising a display adaptation according to embodiments described in the following of this disclosure.

All or some of the algorithms and steps of said processes may be implemented in software form by the execution of a set of instructions by a programmable machine such as a DSP (digital signal processor) or a microcontroller, or be implemented in hardware form by a machine or a dedicated component such as a FPGA (field-programmable gate array) or an ASIC (application-specific integrated circuit). Microprocessors, DSP, FPGA and ASIC are considered as electronic circuitry.

FIG. 4C illustrates a block diagram of an example of a system A implementing a post processing module in which various aspects and embodiments are implemented.

System A can be embodied as a device including various components or modules and is configured to generate a HDR displayable video. Examples of such system include, but are not limited to, various electronic systems such as personal computers, laptop computers, smartphones, tablet, TV, or set top boxes. Components of system A, singly or in combination, can be embodied in a single integrated circuit (IC), multiple ICs, and/or discrete components. For example, in at least one embodiment, the system A comprises one processing module 40 that implements the post-processing module 14. In various embodiments, the system A is communicatively coupled to one or more other systems, or other electronic devices, via, for example, a communication bus or through dedicated input and/or output ports.

The input to the processing module 40 can be provided through various input modules as indicated in a block 42. Such input modules include, but are not limited to, (i) a radio frequency (RF) module that receives an RF signal transmitted, for example, over the air by a broadcaster, (ii) a component (COMP) input module (or a set of COMP input modules), (iii) a Universal Serial Bus (USB) input module, and/or (iv) a High Definition Multimedia Interface (HDMI) input module. Other examples, not shown in FIG. 4C, include composite video.

In various embodiments, the input modules of block 42 have associated respective input processing elements as known in the art. For example, the RF module can be associated with elements suitable for (i) selecting a desired frequency (also referred to as selecting a signal, or band-limiting a signal to a band of frequencies), (ii) down-converting the selected signal, (iii) band-limiting again to a narrower band of frequencies to select (for example) a signal frequency band which can be referred to as a channel in certain embodiments, (iv) demodulating the down-converted and band-limited signal, (v) performing error correction, and (vi) demultiplexing to select the desired stream of data packets. The RF module of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, down-converting the received signal to a lower frequency (for example, an intermediate frequency or a near-baseband frequency) or to baseband. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF module includes an antenna.

Additionally, the USB and/or HDMI modules can include respective interface processors for connecting system A to other electronic devices across USB and/or HDMI connections. It is to be understood that various aspects of input processing, for example, Reed-Solomon error correction, can be implemented, for example, within a separate input processing IC or within the processing module 40 as necessary.

Similarly, aspects of USB or HDMI interface processing can be implemented within separate interface ICs or within the processing module 40 as necessary. The demodulated, error corrected, and demultiplexed stream is provided to the processing module 40.

Various elements of system A can be provided within an integrated housing. Within the integrated housing, the various elements can be interconnected and transmit data therebetween using suitable connection arrangements, for example, an internal bus as known in the art, including the Inter-IC (I2C) bus, wiring, and printed circuit boards. For example, in the system A, the processing module 40 is interconnected to other elements of said system A by the bus 405.

The communication interface 404 of the processing module 40 allows the system A to communicate on the communication network 41. The communication network 41 can be implemented, for example, within a wired and/or a wireless medium.

Data is streamed, or otherwise provided, to the system A, in various embodiments, using a wireless network such as a Wi-Fi network, for example IEEE 802.11 (IEEE refers to the Institute of Electrical and Electronics Engineers). The Wi-Fi signal of these embodiments is received over the communications network 41 and the communications interface 404 which are adapted for Wi-Fi communications. The communications network 41 of these embodiments is typically connected to an access point or router that provides access to external networks including the Internet for allowing streaming applications and other over-the-top communications. Still other embodiments provide streamed data to the system A using the RF connection of the input block 42. As indicated above, various embodiments provide data in a non-streaming manner, for example, when the system A is a smartphone or a tablet. Additionally, various embodiments use wireless networks other than Wi-Fi, for example a cellular network or a Bluetooth network.

The system A can provide an output signal to various output devices using the communication network 41 or the bus 405. For example, the system A can provide a reconstructed HDR video.

The system A can provide an output signal to various output devices, including the HDR display 15, speakers 46, and other peripheral devices 47. The HDR display 15 of various embodiments includes one or more of, for example, a touchscreen display, an organic light-emitting diode (OLED) display, a curved display, and/or a foldable display. The HDR display 15 can be for a television, a tablet, a laptop, a cell phone (mobile phone), or other devices. The HDR display 15 can also be integrated with other components (for example, as in a smart phone), or separate (for example, an external monitor for a laptop). The other peripheral devices 47 include, in various examples of embodiments, one or more of a stand-alone digital video disc (or digital versatile disc) (DVR, for both terms), a disk player, a stereo system, and/or a lighting system. Various embodiments use one or more peripheral devices 47 that provide a function based on the output of the system A. For example, a disk player performs the function of playing the output of the system A.

In various embodiments, control signals are communicated between the system A and the HDR display 15, speakers 46, or other peripheral devices 47 using signaling such as AV.Link, Consumer Electronics Control (CEC), or other communications protocols that enable device-to-device control with or without user intervention. The output devices can be communicatively coupled to system A via dedicated connections through respective interfaces 43, 44, and 45. Alternatively, the output devices can be connected to system A using the communication network 41 via the communication interface 404. The HDR display 15 and speakers 46 can be integrated in a single unit with the other components of system A in an electronic device such as, for example, a television. In various embodiments, the display interface 43 includes a display driver, such as, for example, a timing controller (T Con) chip.

The HDR display 15 and speakers 46 can alternatively be separate from one or more of the other components, for example, if the RF module of block 42 is part of a separate set-top box. In various embodiments in which the HDR display 15 and speakers 46 are external components, the output signal can be provided via dedicated output connections, including, for example, HDMI ports, USB ports, or COMP outputs.

FIG. 4B illustrates a block diagram of an example of the system B adapted to implement the pre-processing module 11 in which various aspects and embodiments are implemented.

System B can be embodied as a device including the various components and modules described above and is configured to perform one or more of the aspects and embodiments described in this document.

Examples of such devices include, but are not limited to, various electronic devices such as personal computers, laptop computers, a camera, a smartphone and a server. Elements or modules of system B, singly or in combination, can be embodied in a single integrated circuit (IC), multiple ICs, and/or discrete components. For example, in at least one embodiment, the system B comprises one processing module 40 that implement the pre-processing module 11. In various embodiments, the system B is communicatively coupled to one or more other systems, or other electronic devices, via, for example, a communications bus or through dedicated input and/or output ports.

The input to the processing module 40 can be provided through various input modules as indicated in block 42 already described in relation to FIG. 4C.

Various elements of system B can be provided within an integrated housing. Within the integrated housing, the various elements can be interconnected and transmit data therebetween using suitable connection arrangements, for example, an internal bus as known in the art, including the Inter-IC (I2C) bus, wiring, and printed circuit boards. For example, in the system B, the processing module 40 is interconnected to other elements of said system B by the bus 405.

The communication interface 404 of the processing module 40 allows the system B to communicate on the communication network 41. The communication network 71 can be implemented, for example, within a wired and/or a wireless medium.

Data is streamed, or otherwise provided, to the system B, in various embodiments, using a wireless network such as a Wi-Fi network, for example IEEE 802.11 (IEEE refers to the Institute of Electrical and Electronics Engineers). The Wi-Fi signal of these embodiments is received over the communications network 41 and the communications interface 404 which are adapted for Wi-Fi communications. The communications network 41 of these embodiments is typically connected to an access point or router that provides access to external networks including the Internet for allowing streaming applications and other over-the-top communications. Still other embodiments provide streamed data to the system B using the RF connection of the input block 42. As indicated above, various embodiments provide data in a non-streaming manner.

When a figure is presented as a flow diagram, it should be understood that it also provides a block diagram of a corresponding apparatus. Similarly, when a figure is presented as a block diagram, it should be understood that it also provides a flow diagram of a corresponding method/process.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented, for example, in a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), smartphones, tablets, and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information can include one or more of, for example, estimating the information, calculating the information, predicting the information, retrieving the information from memory or obtaining the information for example from another device, module or from user.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, “one or more of” for example, in the cases of “A/B”, “A and/or B” and “at least one of A and B”, “one or more of A and B” is intended to encompass the selection of the first listed option (A) only, or the selection of the second listed option (B) only, or the selection of both options (A and B). As a further example, in the cases of “A, B, and/or C” and “at least one of A, B, and C”, “one or more of A, B and C” such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

As will be evident to one of ordinary skill in the art, implementations or embodiments can produce a variety of signals formatted to carry information that can be, for example, stored or transmitted. The information can include, for example, instructions for performing a method, or data produced by one of the described implementations or embodiments. For example, a signal can be formatted to carry a SDR image or video sequence and SL-HDRx metadata of a described embodiment. Such a signal can be formatted, for example, as an electromagnetic wave (for example, using a radio frequency portion of spectrum) or as a baseband signal. The formatting can include, for example, encoding a SDR image or video sequence with SL-HDR1 metadata in an encoded stream and modulating a carrier with the encoded stream. The information that the signal carries can be, for example, analog or digital information. The signal can be transmitted over a variety of different wired or wireless links, as is known. The signal can be stored on a processor-readable medium.

As seen above, display adaptation allows displaying a HDR video compliant with a target display peak luminance corresponding to the peak luminance supported by a display device on which is displayed the HDR video while preserving the artistic intent of the content creator. Nevertheless, in that case, the energy consumed by the display device corresponds to the maximum of the energy that can be consumed by the display device to display the HDR video.

A common objective of the various embodiments described in the following is to decrease the consumption of the display device when displaying the HDR video with respect to this maximum of energy. To do so, a peak luminance, called energy consumption based peak luminance in the following, lower than the target display peak luminance and corresponding to an energy reduction target or to an adequate profile selected by a end-user, is used in place of the target display peak luminance in the display adaptation process. Using an energy consumption based peak luminance lower than the target display peak luminance has a direct impact on the energy consumption reduction.

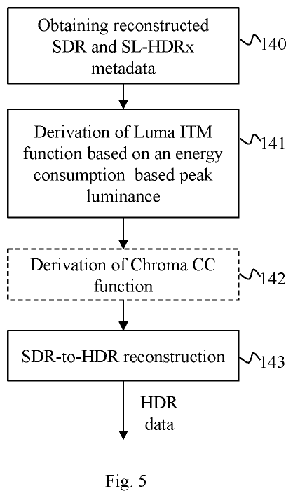

FIG. 5 illustrates a post-processing process allowing controlling the energy consumed by a display device when displaying an HDR video.

The post-processing process described in FIG. 5 is for instance executed by the processing module 40 of the system A when this processing module 40 implements the post-processing module 14. The system A is supposed to have received encoded video data from the system B. The decoding module 13 of the system A has then decoded the encoded video data and has generated reconstructed SDR data and SL-HDR1 metadata. The post-processing module 14 then obtains the reconstructed SDR data and the SL-HDR1 metadata from the decoding module 13.

One can note that in the following description, we took the example of SL-HDR1. However, the various embodiments described in the following apply to any other HDR distribution technology using dynamic metadata such as SL-HDR2, SL-HDR3, Dolby Vision and HDR10+. In addition, the various embodiments use a modified version of the display adaptation process described in annex E of SL-HDR1. However, other display adaptation process can be used, the display adaptation process described in annex E of SL-HDR1 being just an example of such process.

In a step 140, the processing module 40 of the post-processing module 14 obtains the reconstructed SDR data and metadata representative of a first inverse tone mapping function allowing transforming the reconstructed SDR data into HDR data with a dynamic range having a first peak luminance. In the example of FIG. 5, the metadata are SL-HDR1 metadata generated by the pre-processing module 11. The first peak luminance is the master display peak luminance corresponding to the peak luminance defined by the content creator.

In a step 141, the processing module 40 derives, using the metadata, a second tone mapping function allowing transforming the SDR data into HDR data with a dynamic range having a second peak luminance lower than the first peak luminance. The second peak luminance is typically the energy consumption based peak luminance mentioned above. To do so, the processing module 40 applies for example the display adaptation process described in annex E of document SL-HDR1 by replacing the variable L_{pdisp} representing the target display peak luminance (i.e. the maximum luminance of the presentation display) by a variable L_{energyConso} representing the energy consumption based peak luminance. The computation of the first LUT lutMapY′( ) representative of the ITM curve without display adaption is not modified. The replacement of the variable L_{pdisp} by the variable L_{energyConso} allows obtaining a second LUT lutMapY″_{energyConso}( ) allowing mapping the HDR signal with a peak of luminance equal to the master display peak luminance to a HDR signal with a peak luminance equal to the energy consumption based peak luminance. The LUT lutMapY( ) is then the combination of the first LUT lutMapY′( ) and the second LUT lutMapY″_{energyConso}( ).

In a step 143, the processing module 40 reconstructs the HDR data using the second tone mapping function (i.e. using the LUT lutMapY( )), the HDR data being intended to be displayed on the HDR display 15.

One can note that the energy based peak luminance is lower than the target display peak luminance representing the peak luminance supported by the HDR display 15.

Optionally, when the SDR data comprise chroma components, the SL-HDR1 metadata comprise information representative of a color correction function and the processing module 40 derives the color correction function in a step 142 as described in the document SL-HDR1. In step 143, the processing module 40 applies the color correction function to the SDR data to obtain the chrominance components of the HDR data.

In a first embodiment of step 141, a end user defines an energy consumption reduction target. The energy consumption reduction target can be a simple scalar value A selected by the end-user in a pre-defined range for instance between zero and 50%. This scalar value reflects the energy reduction that the end user wants to achieve with respect to the energy consumption that would be obtained by applying a display adaptation with a target peak luminance equal to the target display peak luminance (for instance by using the target display peak luminance in the display adaptation process of Annex E of document SL-HDR1 instead of the energy consumption based peak luminance).

In a first variant of the first embodiment, the scalar value is converted in a reduction factor γ=1−Δ. For instance, if Δ=10%, γ=1−0.1=0.9. The reduction factor is then applied to the target display peak luminance value TargetDisplayPeakLum to obtain the energy consumption based peak luminance value EnergyConsoPeakLum:

$$EnergyConsoPeakLum = γ \times TargetDisplayPeakLum$$

In the first variant of the first embodiment, it is assumed that the energy consumption increases linearly with the peak luminance values (i.e., with the emitted light). This assumption is not always correct and the relation between the energy consumption values and the peak luminance values is generally better represented by a piece wise linear curve or a parametric curve. A piece wise linear curve can be represented by several control points. Two successive control points of the piece wise linear curve are for example C_{display|peakLuminance1} and C_{display|peakLuminance2}. The first control point C_{display|peakLuminance1} defines an energy consumption value for a given peak luminance value peakLuminance1. The second control point C_{display|peakLuminance2} defines an energy consumption value for a smaller peak luminance value peakLuminance2 (peakLuminance1>peakLuminance2). The piece wise linear curve could be represented by a minimum of two control points. The computation of an energy consumption based peak luminance value in function of an expected energy consumption reduction value consists in performing a linear interpolation between two control points of the piece wise linear curve.

In a second variant of the first embodiment, the processing module 40 implements a converter allowing converting an energy consumption reduction value into a value of energy consumption based peak luminance using a piece wise linear curve defined by a plurality of control points. The control points defining this curve were obtained offline for example by measuring the energy consumed by a display device when applying the display adaptation process of annex E of SL-HDR1 on a large number of video sequences with various values of energy consumption based peak luminance.

The first and second variant of the first embodiment estimates a value of energy consumption based peak luminance in function of an energy consumption reduction value without any prior knowledge on the content represented by the HDR data. Converting an energy consumption reduction value into a value of energy consumption based peak luminance may be difficult without prior knowledge of the content represented by the HDR data. Therefore, even if an energy reduction is obtained with this first and second variant, it may not respect the expected energy consumption reduction.

In a third variant of the first embodiment, the system B (for instance the pre-processing module 11 or the encoding module 12 of system B) estimates the energy consumed for displaying the original HDR data and translates this energy consumption information into new additional Energy Aware metadata embedded in the video data transmitted to the system A. The energy aware metadata allow estimating an energy consumed by a display device for displaying the HDR data with a peak luminance equal to an energy consumption based peak luminance for instance defined by an end user.

The advantage of this embodiment is that the converter allowing converting an energy consumption reduction value into a value of energy consumption based peak luminance takes into account the information represented by the energy aware metadata to improve the accuracy of the conversion.

In an embodiment, the energy aware metadata is an information computed by the system B (for instance by the pre-processing module 11 or by the encoding module 12 of the system B) representative of an actual energy consumption or of an estimation of an energy consumption for displaying the content represented by the HDR data for a given display type.

In an embodiment, the information is a single value C_{display|peakluminance} representing the energy actually consumed to display the content on the given display device.

The energy consumption based peak luminance value EnergyConsoPeakLum can be computed as follows:

$$EnergyConsoPeakLum = \frac{targetConsumption}{{C}_{display \vert peakLuminance}} \times TargetDisplayPeakLum$$

where targetConsumption represent a target energy consumption that can be defined as a percentage (i.e. as an energy consumption reduction target) of the information C_{display|peakLuminane}, the percentage being given by the end-user. Here again, it is assumed that the energy consumption increases linearly with the peak luminance values.

As seen already above, piece wise linear curves or parametric curves offer generally a better representation of the relation between the energy consumption values and the peak luminance values.

In another embodiment, the energy aware metadata comprise for instance information representative of a plurality of control points (or parameters of a parametric curve) allowing constructing a curve representing peak luminance values in function of energy consumption values adapted to the content represented by the HDR data.

The energy aware metadata are dynamic metadata that can be presented with different temporal granularities. They can be provided on an image basis, per groups of images, between two scene cuts, per program, for a period, for a duration, for a temporal layer, etc.

In addition to the data allowing performing the conversion between energy consumption reduction values and peak luminance values, the energy aware metadata can comprise various information allowing improving the accuracy of the conversion such as:
data representing conversion curves (piece wise linear curves or parametric curves) for a plurality of types of display devices (LCD screens (e.g., reference model, Abaqus), RGB OLED screens (e.g., black and white points, parametric curve), RGBW OLED screens (e.g., black and white points, parametric curve));
A percentage of the maximum consumption of the current image on a given temporal resolution;
Average luminance of images;
Information representative of a spatio-temporal event such as a scene cut, a fade, etc.
Information representative of a type of the content (e.g., sport, news, documentary, movies, etc)

The energy aware metadata can be embedded in a proprietary field for instance in the SL-HDR1 (SL-HDR2, SL-HDR3, Dolby Vision or HDR10+) metadata or into metadata associated with the encoded video data such as in dedicated SEI (supplemental enhancement information) messages as defined in AVC, HEVC or VVC.

In a second embodiment of step 141 the energy consumption reduction target is an energy consumption profile selected by the end-user among pre-defined energy consumption profiles. In that case, a value of energy consumption based peak luminance is known for each profile. For instance, the following profiles are defined:
High energy: the display adaptation process mode uses a target peak luminance equal to the target display peak luminance. The energy consumption is not reduced and the QoE is maximal (i.e., the display adaptation process of Annex E of SL-HDR1 is applied with no modification);
Normal energy: the display adaptation process mode uses a target peak luminance equal to a first predefined energy consumption based peak luminance (i.e., the display adaptation process of Annex E of SL-HDR1 is applied with the first predefined energy consumption based peak luminance). The energy consumption is reduced but the QoE is still high;
Low energy: the display adaptation process mode uses a target peak luminance equal to a second predefined energy consumption based peak luminance lower than the first predefined energy consumption based peak luminance (i.e. the display adaptation process of Annex E of SL-HDR1 is applied with the second predefined energy consumption based peak luminance). The energy consumption is reduced and the QoE is decreasing.

In a third embodiment of step 141, the energy consumption based peak luminance is defined directly by the end user for instance at the level of the HDR display 15 using a user interface of the display device. In that case, the HDR display 15 advertises the system A (and the post-processing module 14) of a value of peak luminance it supports equal to the energy consumption based peak luminance defined by the user instead of the target display peak luminance.

The first, second and third embodiments allow determining an energy consumption based peak luminance per image. In a fourth embodiment, in order to prevent flickering, the determined energy consumption based peak luminance for an instant t EnergyConsoPeakLum(t) is smoothed over time. A simple approach with a temporal window of size T is described below:

$$EnergyConsoPeakLum ( t ) = {\sum }_{i = 0}^{T - 1} {a}_{i} \times EnergyConosPeakLum ( t - i )$$

αᵢ are weighting factors. Several methods for determining the weighting factors αᵢ are described below:
Uniform weighting: αᵢ=1/T;
Exponential smoothing: Past observations are weighted with a decreasing ratio, with the weights decaying exponentially as the observations get older. In other words, the more recent the observation the higher the associated weight. For instance

$${a}_{i} = exp ( - \frac{i}{{σ}^{2}} ) ,$$

where σ is a factor to control a decay velocity. σ is often set to a value between “0” and “1”. Large values mean that the model pays attention mainly to the most recent past observations, whereas smaller values mean more of the history is taken into account when making a prediction.

In a fifth embodiment of step 141, in order to limit the impact on the QoE, a minimal value MinPeakLum is defined for the energy consumption based peak luminance EnergyConsoPeakLum. In this fifth embodiment, the energy consumption based peak luminance EnergyConsoPeakLum is computed as follows:

$$EnergyConsoPeakLum = max ( Min L eakLum ; EnergyConsoPeakLum ) Where max ( x ; y ) takes the maximum between x and y .$$

In a sixth embodiment of step 141, a strategy to reduce the energy consumption is based on spatio-temporal events such as scene cuts. For example, before and after scene cuts, the energy consumption based peak luminance EnergyConsoPeakLum is systematically decreased with respect to the target display peak luminance TargetDisplayPeakLum using for example one of the first to the fifth embodiments.

In a seventh embodiment of step 141, the application of the display adaptation process of the first to the sixth embodiments is content adaptive. Indeed, the application of a display adaptation process on some specific contents has a few impact on the energy consumption. For example, a dark content leads to very low energy reduction whatever the display adaptation process is used. For such contents, the total amount of luminance per image might be computed and when lower than a given threshold, the display adaptation process of the first to the sixth embodiments is disabled. To avoid a hard thresholding, a piece-wise linear function or a parametric function can be used to define appropriate weightings. One way to do that is to linearly combine the target display peak luminance TargetDisplayPeakLum with the energy consumption based peak luminance EnergyConsoPeakLum determined by the display adaptation process as follows:

$$EnergyConsoPeakLum = a \times EnergyConsoPeakLum + ( 1 - a ) \times TargetDisplayPeakLum$$

where α is a weighting factor:
   α=0: the display adaptation process of the first to the sixth embodiment is disabled. In that case, for instance, the display adaptation process described in Annex E of SL-HDR1 is applied with no modification.
   α=1: the display adaptation process of the first to the sixth embodiment is applied.

The weighting factor α can be computed thanks to different methods as follows:
Hard thresholding given a predefined threshold:

$$a = \{ \begin{matrix}0 if potential < threshold \\ 1 otherwise\end{matrix}$$

Soft thresholding:

$$a = 1 - exp ( - {potential}^{2} / {σ}^{2} )$$

Where σ is a factor controlling the decay velocity of the exponential function.

potential is a positive scalar value indicating a potential of a current image to reduce energy consumption. The potential of a dark image is low whereas the potential of a bright image is much higher. When the potential is high, a should tend to “1”.

In an embodiment, the positive scalar value potential of a HDR image is estimated from a normalized cumulated histogram of the reconstructed SDR image corresponding to the HDR image. As a reminder, each bin of a cumulated histogram of an image associates a first sample value (a value between “0” and “255” for a SDR image) to the number of samples of the image having a sample value below or equal to the first sample value. A normalized cumulated histogram is obtained by dividing the number of samples of each bin by the total number of samples in the image. The positive scalar value potential is a first sample value of the cumulated histogram for which the associated normalized number of samples of the image having a sample value below or equal to the first sample value is equal to a predefined sample value β. For example, β=0.9 indicating that 90% of the samples of the image have a sample value lower or equal to the first sample value. In the hard thresholding for example, if threshold=50 and potential=30 (meaning that 90% of the samples of the reconstructed SDR image has a sample value lower than or equal to “30”), the display adaptation process of the first to the sixth embodiments is not applied.

The potential value potential can also depend on a motion activity in the content or more generally can be a function of a potential of masking a variation of the luminance of the images. Indeed, it is known that a variation of peak luminance in a sequence of consecutive images is less noticeable for the end user if the sequence shows a high motion than in a static sequence. For example, the positive scalar value potential of a HDR frame can be computed as a sum of the norm of the motion vectors of the blocks of the corresponding reconstructed SDR image or as a sum of the residual values of the blocks of the corresponding reconstructed SDR image. If the potential value potential is representative of a slow motion, the display adaptation process of the first to the sixth embodiments is not applied. Otherwise, in case of high motion, the display adaptation process of the first to the sixth embodiments is applied. One can note that the information on motion vectors or on residual values can be provided by the decoding module 13, the potential value potential being computed by the post-processing module 14. One can note that other coding information can be used to determine the potential value potential such as information on the partitioning of images or of blocks, statistics on blocks coded in INTRA mode and on blocks coded in INTER modes, etc.

In a variant of the seventh embodiment, the display adaptation process of the first to the sixth embodiments is disabled on a sub-frame basis, on a group of frames basis, per shot, per movie depending respectively on the content of the group of frames, of the shot or of the movie.

We described above a number of embodiments. Features of these embodiments can be provided alone or in any combination. Further, embodiments can include one or more of the following features, devices, or aspects, alone or in any combination, across various claim categories and types:
A bitstream or signal that includes a SDR video and energy aware metadata, or variations thereof.
Creating and/or transmitting and/or receiving and/or decoding a bitstream or signal that includes a SDR video and energy aware metadata, or variations thereof.
A server, camera, TV, set-top box, cell phone, tablet, personal computer or other electronic device that performs at least one of the embodiments described.
A TV, set-top box, cell phone, tablet, personal computer or other electronic device that performs at least one of the embodiments described, and that displays (e.g., using a monitor, screen, or other type of display) a resulting picture.
A TV, set-top box, cell phone, tablet, personal computer or other electronic device that tunes (e.g., using a tuner) a channel to receive a signal including an encoded SDR video and energy aware metadata, and performs at least one of the embodiments described.
A TV, set-top box, cell phone, tablet, or other electronic device that receives (e.g., using an antenna) a signal over the air that includes an encoded SDR video and energy aware metadata, and performs at least one of the embodiments described.
A server, camera, cell phone, tablet, personal computer or other electronic device that tunes (e.g., using a tuner) a channel to transmit a signal including a SDR video and energy aware metadata, and performs at least one of the embodiments described.
A server, camera, cell phone, tablet, personal computer or other electronic device that transmits (e.g., using an antenna) a signal over the air that includes a SDR video and energy aware metadata, and performs at least one of the embodiments described.

1. A method comprising:
obtaining reconstructed SDR data and metadata representative of a first inverse tone mapping function allowing transforming the reconstructed SDR data into HDR data with a dynamic range having a first peak luminance;
deriving, using the metadata, a second tone mapping function allowing transforming the SDR data into HDR data with a dynamic range having a second peak luminance lower than the first peak luminance, the second peak luminance being derived from an information representative of the second peak luminance, the information representative of the second peak luminance being an energy consumption reduction target or an energy consumption profile selected in a plurality of energy consumption profiles; and,
reconstructing the HDR data using the second tone mapping function, the HDR data being intended to be displayed on a display device;
wherein:
the second peak luminance is lower than a third peak luminance, the third peak luminance being the maximum peak luminance supported by the display device.

2. The method of claim 1, wherein the information representative of the second peak luminance is provided by a user.

3. (canceled)

4. The method of claim 3, wherein the energy consumption reduction target is converted in the second peak luminance either based on an information allowing determining a reduction factor to be applied to the third peak luminance to obtain the second peak luminance, based on a piece wise linear curve or based a parametric curve, the piece wise linear curve or the parametric curve being represented by at least two different control points, each control point defining an energy consumption value for a given peak luminance value.

5. The method of claim 4, wherein control points allowing defining the piece wise linear curve or the parametric curve were obtained offline using a large number of video sequences.

6. The method of claim 1, wherein the information allowing determining a reduction factor or control points allowing defining the piece wise linear curve or the parametric curve were obtained from the metadata.

7. The method of claim 6, wherein the metadata are dynamic metadata provided for each image of the SDR data or for groups of images of the SDR data between two scene cuts of the SDR data or per program of the SDR data or per periods of the SDR data for a duration or for a temporal layer of the SDR data.

8. The method of claim 6, wherein the metadata comprise in addition an information representative of an average luminance of images, information representative of a spatio-temporal event, information representative of a type of a content represented by the SDR data.

9. The method claim 1, wherein the second peak luminance of a current image results from a smoothing based on second peak luminance values of images preceding the current image.

10. The method of claim 1, wherein the second peak luminance is greater or equal to a minimum value.

11. The method of claim 1, wherein a content adaptive process determines whether the reconstructing of the HDR data uses the second tone mapping function.

12. The method of claim 11, wherein the content adaptive process uses a potential value indicating a capacity of a current image to reduce energy consumption.

13-15. (canceled)

16. A device comprising electronic circuitry configured for:
obtaining reconstructed SDR data and metadata representative of a first inverse tone mapping function allowing transforming the reconstructed SDR data into HDR data with a dynamic range having a first peak luminance;
deriving, using the metadata, a second tone mapping function allowing transforming the SDR data into HDR data with a dynamic range having a second peak luminance lower than the first peak luminance, the second peak luminance being derived from an information representative of the second peak luminance, the information representative of the second peak luminance being an energy consumption reduction target or an energy consumption profile selected in a plurality of energy consumption profiles; and,
reconstructing the HDR data using the second tone mapping function, the HDR data being intended to be displayed on a display device;
wherein:
the second peak luminance is lower than a third peak luminance, the third peak luminance being the maximum peak luminance supported by the display device.

17. The device of claim 16, wherein the information representative of the second peak luminance is provided by a user.

18. (canceled)

19. The device of claim 16, wherein the energy consumption reduction target is converted in the second peak luminance either based on an information allowing determining a reduction factor to be applied to the third peak luminance to obtain the second peak luminance, based on a piece wise linear curve or based on a parametric curve, the piece wise linear curve or the parametric curve being represented by at least two different control points, each control point defining an energy consumption value for a given peak luminance value.

20. The device of claim 19, wherein control points allowing defining the piece wise linear curve or the parametric curve were obtained offline using a large number of video sequences.

21. The device of claim 19, wherein the information allowing determining a reduction factor and control points allowing defining the piece wise linear curve or the parametric curve were obtained from the metadata.

22. The device of claim 21, wherein the metadata are dynamic metadata provided for each image of the SDR data or for groups of images of the SDR data or between two scene cuts of the SDR data or per program of the SDR data or per periods of the SDR data or for a duration or for a temporal layer of the SDR data.

23. The device of claim 22, wherein the metadata comprise in addition an information representative of an average luminance of images, information representative of a spatio-temporal event, information representative of a type of a content represented by the SDR data.

24. The device of claim 16, wherein the second peak luminance of a current image results from a smoothing based on second peak luminance values of images preceding the current image.

25. The device of claim 16, wherein the second peak luminance is greater or equal to a minimum value.

26-33. (canceled)
